(19) United States
(12) Patent Application Publication
(10) Pub. No.: US 2012/0005590 A1
(43) Pub. Date: Jan. 5, 2012

(54) SYSTEM AND METHOD FOR WEB-ENABLED ENTERPRISE ENVIRONMENT CONTROL AND ENERGY MANAGEMENT

(75) Inventors: Stuart LOMBARD, Toronto (CA); Mark MACHIONDO, Mississauga (CA); Chris CARRADINE, Toronto (CA); Brian PARKINSON, Toronto (CA)

(73) Assignee: ECOBEE INC., Toronto (CA)

(21) Appl. No.: 13/231,721

(22) Filed: Sep. 13, 2011

Related U.S. Application Data
(63) Continuation of application No. 13/020,133, filed on Feb. 3, 2011.
Application No. 13/020,133 is a continuation-in-part of application No. 12/699,569, filed on Feb. 3, 2010, now abandoned.

(51) Int. Cl. G06F 3/048; G06F 15/16

(52) U.S. Cl. 715/742

(57) ABSTRACT

A system and method for an environment control and energy management. The system includes a server computer, at least one environment control device (ECD) and at least one mobile device communicatively coupled via a web-based communication system. A mobile device, also having a touch screen display, may be configured to display a replica screen of the touch screen user interface of the ECD, and allows modification of the control program accessed at the ECD.

This application is a continuation of U.S. patent application Ser. No. 13/020,133 entitled “System and Method for Web-enabled Enterprise Environment Control and Energy Management” (inventors Stuart Lombard et al.) and filed on 3 Feb. 2011, which was a continuation in part of U.S. patent application Ser. No. 12/699,569, filed on 3 Feb. 2010. The contents of U.S. patent application Ser. No. 12/699,569 are incorporated in their entirety, by reference.

### FIELD

The present disclosure relates generally to a system and method for web-enabled enterprise environment control and energy management system and method.

### BACKGROUND

Solutions for efficient management of enterprise energy usage, such as for heating and cooling, contribute not only to reduced energy costs, but also result in a positive environmental impact and a reduced carbon footprint. To the extent that those solutions or tools are made easier and more convenient for a user, more widespread adoption of those solutions or tools should result, and thus promotes energy conservation.

### SUMMARY

What is provided is a method for providing information about a selected environment control device (ECD) to a secondary registrant across a network, the method comprising:

receiving data from a plurality of ECDs at an environment control portal via the network;

receiving a registration request at the environment control portal via the network for registration of a secondary registrant;

authenticating the registration request at the environment control portal;

displaying the registration IDs for a subset of the plurality of ECDs to the secondary registrant, each ECD of the subset of the plurality of ECDs being associated with the secondary registrant;

receiving a selection request from the secondary registrant to display a subset of the data associated with a selected ECD from the subset of the plurality of ECDs; and

broadcasting the subset of data associated with the ECD to the secondary registrant.

Also provided is An environmental control portal for environment control and energy management of an enterprise, the environment control portal comprising: a server computer having a processor; and a memory comprising instructions stored thereon, which, when executed in the processor, cause the processor to implement the steps of

receiving data from a plurality of ECDs via the network;

receiving a registration request for via the network for registration of a secondary registrant;

authenticating the registration;

displaying the registration IDs for a subset of the plurality of ECDs to the secondary registrant, each ECD of the subset of the plurality of ECDs being associated with the secondary registrant;

receiving a selection request from the secondary registrant to display a subset of the data associated with a selected ECD from the subset of the plurality of ECDs; and

broadcasting the subset of data associated with the ECD to the secondary registrant.

### BRIEF DESCRIPTION OF THE DRAWINGS

Embodiments will now be described by way of example only, with reference to the following drawings in which:

FIG. 1 is a schematic illustrating an embodiment of the environment control and energy management system comprising an environment control portal, at least one environment control device and at least one client computing device communicatively coupled via a web-based communication system;

FIG. 2A is a schematic illustrating an electronic architecture of the environment control device shown in FIG. 1;

FIG. 2B is a front plan view of the environment control device shown in FIG. 1, and illustrates external features and screen display attributes of the environment control device;

FIG. 3 is a front plan view of the client computing device shown in FIG. 1, the client computing device having a replica screen of the screen display of the environment control device illustrated in FIG. 2B;

FIG. 4 is a flow chart illustrating an embodiment of a process of the disclosure herein as executed within the environment control and energy management system; and

FIG. 5 is a flow chart illustrating an embodiment of another process of the disclosure herein as executed within the environment control and energy management system.

### DETAILED DESCRIPTION

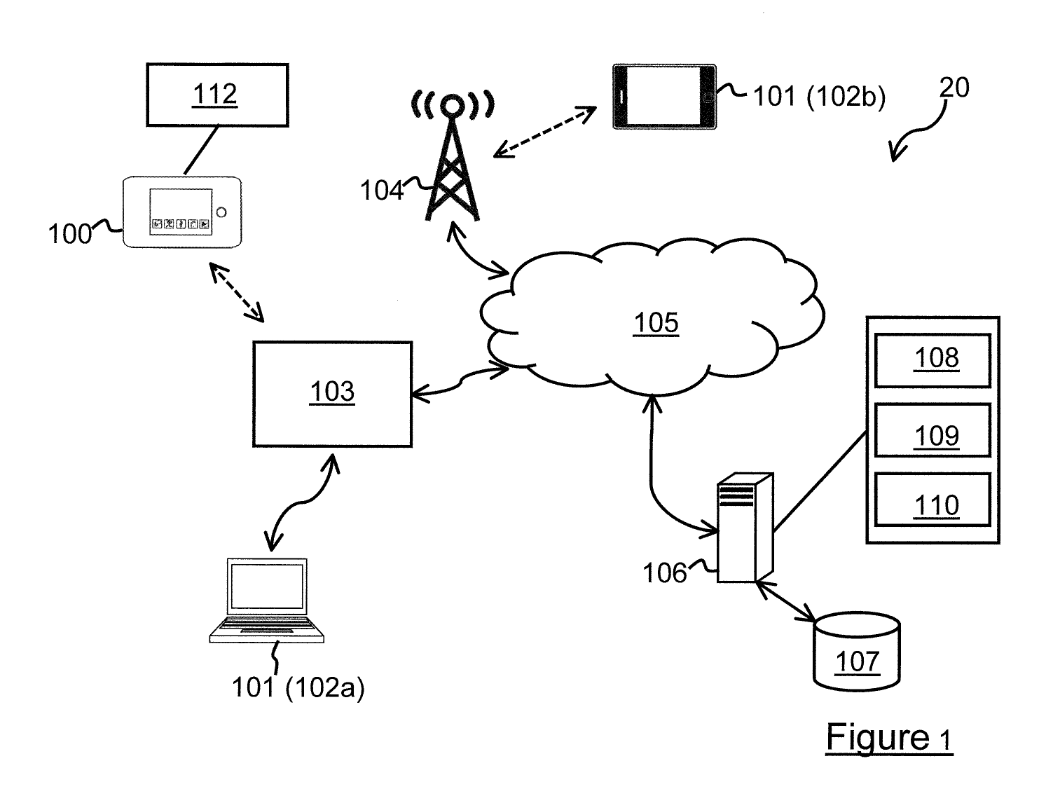

FIG. 1 shows an embodiment of a communication system architecture for accessing an environment control and energy management system (hereinafter ECEMS) 20. ECEMS 20 includes an environment control device (ECD) 100, at least one client computing device 101, and an environment control portal 106, the three being in communication with each other, at least periodically. As is described in greater detail below, the various devices may be in communication using the Internet or other communication system.

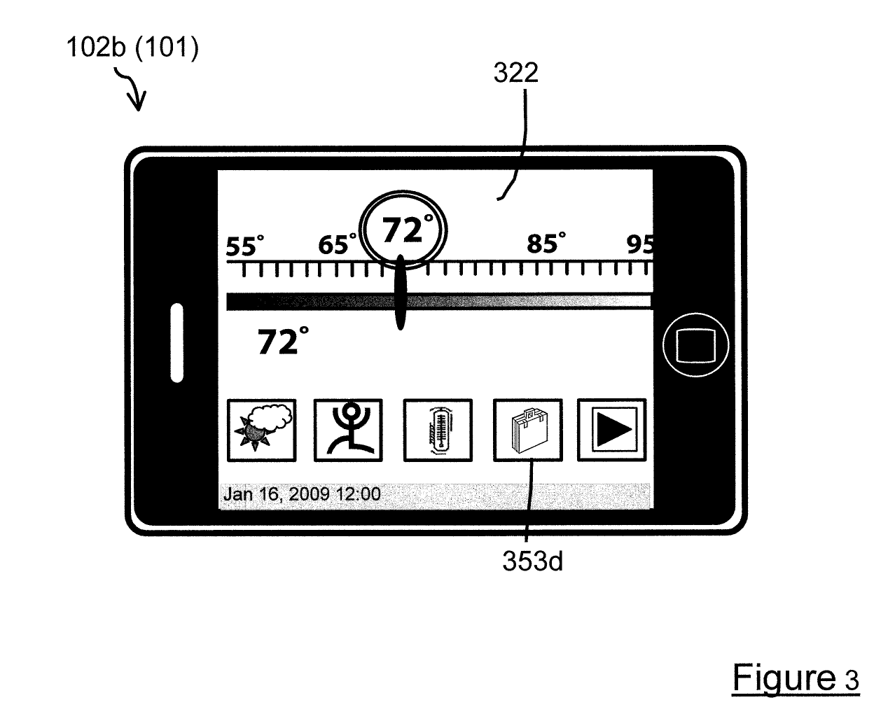

The ECD 100 is typically installed and located within a home, an enterprise or other building premise. The ECD 100 includes an environment interface module 112 (EIM), which may comprise any combination of software, firmware and hardware to sense and monitor prevailing environmental conditions such as temperature and/or humidity. In addition, EIM 112 may be configured to monitor energy consumption, such as electricity or fossil fuel consumption. As will be described in greater detail below, ECD 100 also allows, via its touch screen display 222 (FIG. 3), adjustments related to environment conditions such as via control of a heating, ventilating and air conditioning (HVAC) system installed in the premises, and is able to generate status reports and historical reports for display. In addition, touch screen display 222 may be operable to display energy consumption data for the premise.

The client computing device 101 is located remote from the ECD and can include at least one of a personal computer 102a (including both laptops and desktop computers), and a mobile device 102b, such as mobile phone or Personal Digital Assistant (PDA). The client computing device 101 and most typically the mobile device 102b, may be able to connect to the Internet 105 over a cellular network via a wireless service provider/carrier system infrastructure 104, for example. The client computing device 101, and most typically the personal computer 102b may connect to the Internet 105 or other communication network using an Internet Service Provider (ISP) 103, via either a wired landline connection or a wireless connection, for example. The plurality of client computing devices 101 can be loaded with an appropriate browsing application for accessing and browsing the environment control portal 106 via Internet 105 or other wide area networks (not shown).

The environment control portal 106 may be owned by the environmental control and energy management solutions enterprise that provides and operates the website or web portal application for registered users. Environment control portal 106 acts as a web server and is able to determine and deliver relevant content to ECD 100, and to client computing devices 101 (i.e., mobile device 102a and to personal computer 102b). Environment control portal 106 is further operable to enable remote or web-based management of ECD 100 by client computing devices 101. Environment control portal 106 may have access to one (or more) content database(s) 107. Content databases 107 can include data related to the user account of ECD 100, historical data collected from ECD 100, contractor or manufacturer data, utility data, or auxiliary information (such as weather data). Other content for content databases 107 will occur to those of skill in the art. Environment control portal 106 provides a way for the environmental control and energy solutions enterprise to provide a consistent theme or look and feel, procedures for access, and procedures for use by registered users of client computing devices 101, where those solutions would otherwise have been provided by several disparate entities.

Environment control portal 106 may comprise a plurality of different hardware components including a computer processor, memory, and storage. Environment control portal 106 further includes applicable applications, such as a registration module 108, a browser module 109, and a display configuration module 110. It should also be appreciated that the computer processor is able to execute computer program instructions from memory for carrying out all of the functions of registration module 108, browser module 109 and display configuration module 110.

Registration module 108 may comprise any combination of software, firmware and hardware to authenticate, register and permit access thereto by the users of ECD 100 and client computing devices 101. Users of the different client computing devices 101 may be assigned or allowed different levels of information and control access and functionality. For instance, users defined as primary registrants via ECD 100 and mobile computer 101, may be able to modify the attributes of the environment control program, such as temperature set points and humidity set points, stored at ECD 100.

Other parties, such as service and repair personnel, may be permitted to register the ECD 100, but only as a different class of registrant. The different, or secondary class of registrant might only be entitled to, and permitted access, via environment control portal 106, to a subset of the informational attributes available to a primary registrant or user.

A repair and maintenance service as secondary registrant might be permitted, via their own client computing device (i.e., a service monitoring computer (not shown)) connected to environment control portal 106, the ability to see the location of the ECD 100 to plan service calls, the ability to enter their company logo, contact information and service dates, such that the primary user may get a branded message from the service contractor when maintenance is due, or an alert if an emergency service issue arises. The repair and maintenance service as well may be able to access and see equipment error codes, which allows them to determine the appropriate knowledge level of the service technician to dispatch in responding to the service problem, as well as what parts they may need to resolve the service call. It is contemplated that under the permission rules, the secondary registrant may be to upload information to the ECD 100, such as a company logo and contact information for display of service reminders and service issues. The secondary registrant may also be allowed to set a service date in a web portal hosted at the server computer 106, the service date generating an alert to the ECD 100 to remind the primary registrant of upcoming service scheduled for the service date. The secondary registrant may also be allowed to view the heating, ventilating and air conditioning (HVAC) equipment error codes and status information throughout environment control portal 106, for aid in planning routine service work and expediting service delivery. For confirmation purposes, the secondary registrant may be allowed to view ECD 100 location and upcoming service dates for the primary registrant.

It is also contemplated that a manufacturer of ECD 100, for instance, may register as a different class of secondary registrant (i.e., a tertiary registrant), possibly being allowed even more limited access to informational attributes logged at ECD 100 than the repair and maintenance service. For instance, a manufacturer may register for information that will allow the manufacturer to receive, via the environment control portal 106, reports and error codes. This in turn will allow them to determine (likely on an anonymous basis) how well their equipment performs in the field, and accordingly improve their designs and product development processes.

It is contemplated that a secondary or tertiary registrant may not be permitted to modify the control attributes of the environment control program saved in memory of ECD 100, reserving such capability and privilege solely for the primary registrant.

Browser module 109 provides a portal application which allows ECD 100 and client computing devices 101 to easily access and browse the environment control portal 106 via the web, providing a common web-browsing experience between the devices. It is contemplated that updated versions of browser software or interfaces, when developed at browser module 109, may be broadcast by the environment control portal 106 to any one or all of the plurality of ECDs 100 and client computing devices 101 connected thereto.

Display configuration module 110 may comprise any combination of software, firmware and hardware to enable information attributes and control attributes of the environment control program presented at ECD 100 to be re-configured for presentation at a remote client computing device 101. This preserves a common look and feel of the screen display of ECD 100 as presented across any other accessible client computing devices 101, for instance.

It is contemplated that various components of the disclosure in the depiction of FIG. 1 may be combined into a single computer or server. Or inversely, the various components may be implemented across multiple computers or servers all connected via a communications medium (such as Internet 105). Although a representative single ECD 100 is depicted in FIG. 1, it is contemplated that a cluster of such devices may be managed by one or more portal servers 106 along with a plurality of client computing devices 101 within ECEMS 20.

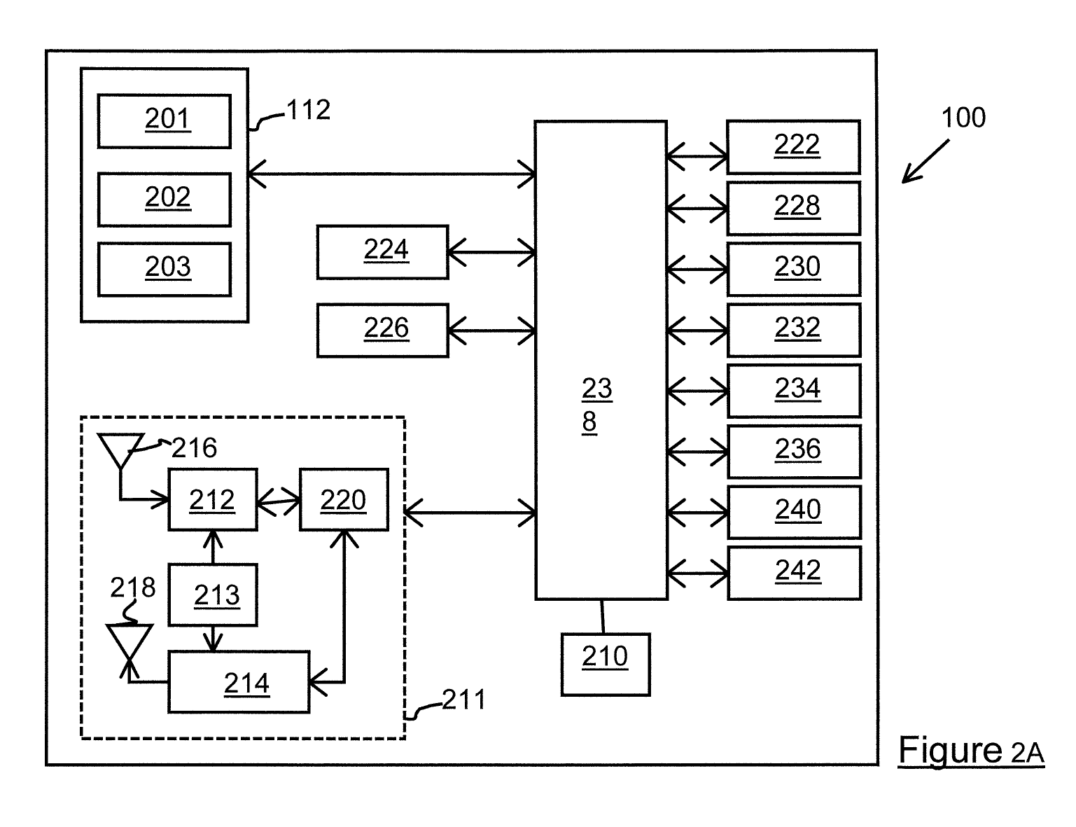

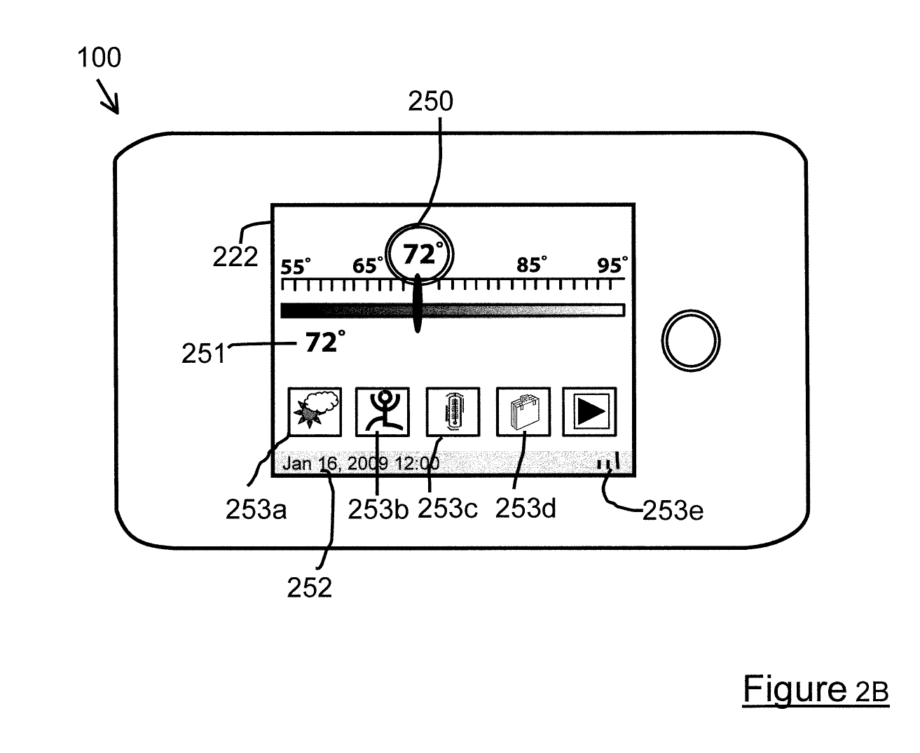

Referring now to FIG. 2A, a schematic of the electronic architecture of the ECD 100 is shown. ECD 100 may include wired or wireless communication capability. In the wireless configuration, ECD typically includes radio frequency (RF) communication subsystem 211, including a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the RF communication subsystem 211 depends on the specific communication network in which ECD 100 is intended to operate, but may include communication functionalities such as radio-frequency identification (RFID), Wi-Fi based on IEEE 802.11 standards, Wi-MAX based on IEEE 802.16 standards, Zigbee®, Zwave™ and the like.

The ECD 100 includes a microprocessor 238 which controls general operation of the ECD 100. The microprocessor 238 also interacts with functional device subsystems such as touch screen display 222, flash memory 224, random access memory (RAM) 226, auxiliary input/output (I/O) subsystems 228, serial port 230, keyboard 232, speaker 234, microphone 236, short-range communications subsystem 240 such as Bluetooth™ for example, and Universal Serial Bus (USB) expansion port 242 for peripheral. The ECD 100 may include a backup power source 210, such as a rechargeable battery which may also be removable and replaceable from the ECD 100.

Operating system software used by the microprocessor 238 may be stored in a persistent store such as flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

The microprocessor 238, in addition to its operating system functions, enables execution of a browser software application on the ECD 100. Additionally, applications may also be subsequently loaded onto the ECD 100 through the communication subsystem 211, an auxiliary I/O subsystem 228, serial port 230, USB port 242, or any other suitable subsystem, and installed by a user in RAM 226, or the flash memory 224, for execution by the microprocessor 238. Such flexibility in application installation increases the functionality of the ECD 100 and may provide enhanced on-device features, communication-related features, or both.

Touch screen display 222 is used to visually present a graphical user interface (GUI) to the user. The user can manipulate data displayed by modifying information on the GUI using direct touches by finger. It is contemplated that, depending on the type of ECD 100, the user may have access to other types of input devices, such as, for example, a scroll wheel, trackball, light pen or touch sensitive screen, and alternatively, keyboard 232.

The touch screen user interface 222 functions both to visually present information via graphical user interface (GUI) to the user and as an input mechanism to manipulate information presented at the GUI. The touch screen display 222 incorporates touch-sensing means based on sensing. The sensing technologies may be capacitive sensing, resistive sensing, surface acoustic wave sensing, pressure sensing, optical sensing, and the like.

It is also contemplated that touch screen display 222 of ECD 100 may also be configured as a multipoint touch input interface, capable of distinguishing multiple touches that occur at the same time. User interface commands or instructions, performed by way of multipoint gestures, directly performed by a user at touch screen display 222 of computing device 100 for example, are gestures that can be performed with multiple points. That is, the gesture is performed with coordinated multiple touches from multiple fingers, fingers, palms and/or side of the hand, a finger and a stylus, or any combination thereof. The multipoint gesture may be dynamic, involving motion.

It is further contemplated that touch screen display 222 may incorporate the input functionality of a keyboard, or a partial set of keyboard keys or buttons, by displaying a replica thereof on the display, whereby the “keys” represented by icons on the screen would be activated by a user touching the icon representing the respective “key” displayed. Alternatively, ECD 100 could include hardware buttons (not shown), that are used in conjunction with the display (i.e., “softkeys”) display, or use fixed-function buttons, or a combination of different kinds of inputs. It is further contemplated that ECD could use also use a non-touch screen display in conjunction with hardware buttons.

As discussed previously, ECD 100 includes the EIM 112 for the sensing and monitoring of prevailing environmental conditions such as temperature and/or humidity, as well as the monitoring of energy consumption. EIM 112 may include a monitoring module 201, control module 202 and report module 203.

Monitoring module 201 may comprise any combination of software, firmware and hardware to sense and monitor prevailing environmental conditions such as temperature and humidity. It can include sensing devices such as thermometers, hygrometers and/or carbon monoxide detectors, or inputs adapted to receive readings from such devices.

Control module 202 of ECD 100 may comprise any combination of software, firmware and hardware to allow, via the touch screen display 222, adjustments related to environment conditions such as via control of a heating, ventilating and air conditioning (HVAC) system installed in the premises (not shown). For example, a set of relays may be provided for controlling HVAC equipment or a communications interface for communicating directly with HVAC system control boards (not shown). The adjustment of control attributes such as temperature and humidity may be initiated and performed not only at the user interface of ECD 100, but also remotely, for instance via connected client computing devices 101.

Report module 203 of ECD 100 may comprise any combination of software, firmware and hardware to record cumulative operating performance, and to generate status reports and historical or statistical reports for display at ECD 100 or any client computing devices 101 that may be allowed data access to ECD 100. For instance, upon the triggering of certain predefined conditions, routine service alerts or other emergency alerts may be dispatched to maintenance or service providers associated with the environment control portal 106 of the ECD 100.

FIG. 2B shows an external front plan view of ECD 100. Attributes of information display and control may be displayed and accessed on touch screen display 222 of ECD 100. The display may be in accordance with a theme or color scheme defining look and feel of the informational and control attributes of ECD 100.

As currently illustrated, touch screen display 222 displays informational attributes such as date and time of day 252, current temperature 251, temperature set point 250, current weather 253a and wireless signal strength 253e. Current weather 253a displays the local external temperature and weather conditions. This information is provided from an external feed (provided via environment control portal 106), a remote temperature sensor connected directly or indirectly to ECD 100 (not shown), or a combination of both an external feed and a remote temperature sensor. It is further contemplated that by pressing current weather 253a, the touch screen display 222 can be temporarily replaced with a long-term forecast (i.e., a 7 day forecast) showing the predicted weather for later times and dates. Again, the information for the long term forecast is provided via environment control portal 106. Other information attributes suitable for display on touch screen display 222 will occur to those of skill in the art.

It is contemplated that the wireless signal strength 253e may also be used to monitor and determine, via monitoring module 201, a communication connectively status of ECD 100. The ECD 100 accordingly send alerts via reporting module 203 and environment control portal 106, to any selected combination of primary and secondary registrants.

Control attributes depicted in FIG. 2B include energy conservation mode icon 253b, program settings icon 253d and humidity set point icon 253c. Energy conservation mode icon 253b (aka “Quicksave”), for example, allows a user to activate the energy conservation mode simply, whereby ECD 100 adjusts the controls of the enterprise environment to operate according to a predetermined energy conservation mode. For instance, an energy conservation mode might comprise adjusting the controls to cause operation at a relatively higher operating temperature and humidity on a hot summer day if the enterprise building is unoccupied, or conversely, to lower the operating temperature on a cold winter day. Program settings icon 253d may be used to program, via the use of touch screen user interface 222, desired temperature set points for each day of the week. If a humidifier or dehumidifier is connected, humidity set point icon 253c may be accessed and adjusted by touch screen user interface input thereon. Humidity set point icon 253c may also be repurposed as a more-generalized “Details” or “Settings” icon to provide additional functionality to the user of ECD 100. Display screen 222 can include other icons and options for functions such as a vacation mode, weather displays, external environmental sensors, and HVAC cleaning operations.

FIG. 3 shows an embodiment of the mobile device 102b comprising a touch screen user interface and display. In this embodiment, as will be described in greater detail below, display configuration module 110 of environment control portal 106 (FIG. 1) may configure the informational and control attributes of ECD 100 as displayed at display screen 222 (FIG. 2B) for display via a replica display screen 322 (FIG. 3) at the touch screen display of mobile device 102b. Configuration module 110 re-configures attributes of the display screen of ECD 100 in order to replicate the overall look and feel or theme, colors, design of the control and informational icons, including the relative spatial arrangements and sizes of the graphical features at replica display screen 322 of mobile device 102b. Display configuration module 110 may therefore need to have knowledge of mobile device 102b's application interface and architecture, such as might be made available via a software development kit (SDK) provided by the manufacturer of mobile device 102b. This enables the display configuration module 110 to advantageously leverage the characteristics of mobile device 102b to maximum advantage, regarding the creation of the replica display screen 322.

In the embodiment depicted in FIG. 3, the replica display screen 322 occupies the full touch screen user interface of mobile device 102b. In this manner, the replica display screen 322 provides to a user of mobile device 102b an experience as if that user were interacting directly with the touch screen user interface 222 of ECD 100, when in fact those devices may be remotely located form each other. Furthermore, the user may proceed to access either the full functionality of display screen 222 of ECD 100 or a substantial subset of the functionality of display screen 222 of ECD 100 while interacting with the replica screen 322. For instance, program settings icon 353d of replica display screen 322 on mobile device 102b may be used to access and program, by touch screen user interface input thereon, desired temperature set points for each day of the week, just as a user would interact directly with program settings icon 253d at ECD 100. Although FIG. 3 illustrates a replica display screen 322 on the touch screen user interface of mobile device 102b, those of skill in the art will recognize that the replica display screen 322 can also be manifested using the display and input mechanisms provided by personal computer 102a or other mobile device. Replica display screen 322 may omit some of the program setting icons found on display screen 222 of ECD 100 that may not be pertinent on the mobile device. For example, the replica display screen 322 might omit replicating the current weather 253a icon as the current weather display may not be applicable, or may even be confusing, on the mobile device.

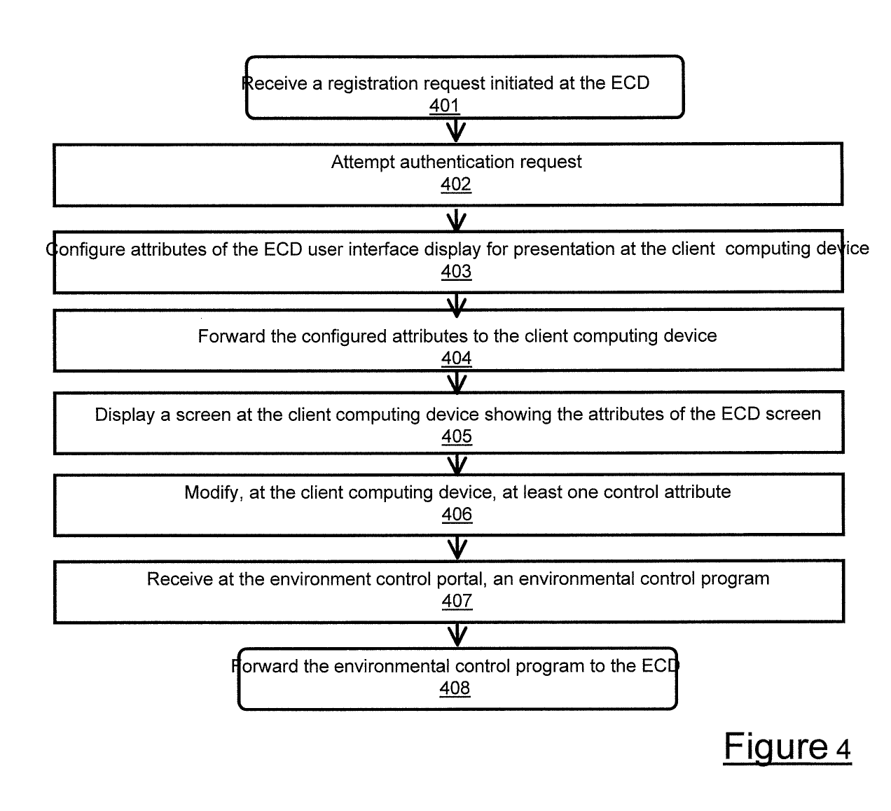

FIG. 4 is a process implemented at environment control portal 106 for registration of an ECD 100, and subsequent modification of the environmental program of ECD 100 using a client computing device 101.

Beginning at step 401, a registration request initiated at an ECD 100 for registration as a primary registrant is received at environment control portal 106. The ECD 100 has a touch screen display 222 coupled to a memory 224, 226 via microprocessor 238, the ECD further having a plurality of graphical information attributes and a plurality of control attributes stored in the memory 224, 226, the touch screen display 222 of the ECD providing access to the graphical information attributes and control attributes of the ECD 100.

At step 402, the registration module 108 of the server portal 206 attempts authentication of the registration request. If necessary, after the server portal 206 receives the registration request from the ECD 100, the primary registrant logs into the portal to complete the registration.

At step 403, upon authenticating the registration request, the server portal 206 assigns the registrant primary registrant status. The display configuration module 110 of environment control portal 106 configures the respective pluralities of attributes of the touch screen display 222 of the ECD 100 for presentation at a user interface display of a client computing device 101.

At step 404, display configuration module 110 of environment control portal 106 forwards the configured pluralities of control attributes to the client computing device 101. As discussed previously, client computing device 101 can include either a personal computer 102a (including both laptops and desktop computers), or a mobile device 102b.

At step 405, a replica screen is displayed at client computing device 101 showing the control attributes of the touch screen display 222. At step 406, at the client computing device 101, a modification is made to at least one of the control attributes.

At step 407, the environment control portal 106 receives from the client computing device 101 the modification to the one control attribute of the plurality of control attributes of the ECD 100, thereby creating a modified plurality of control attributes, with the modified plurality of control attributes comprising an environment control program.

At step 408, environment control portal 106 forwards the environment control program to the ECD 100 for storage in at least one of memory 224, 226.

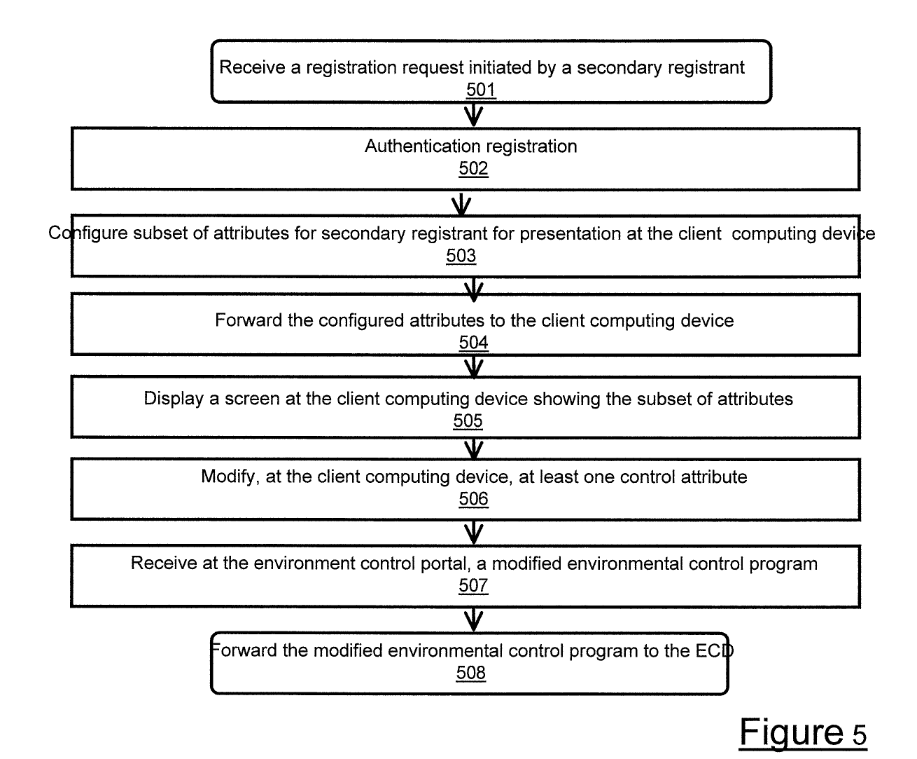

FIG. 5 is a process implemented at environment control portal 106 for registration of a secondary registrant on the ECD 100.

Beginning at step 501, a registration request initiated on ECEMS 20 for registration of a secondary registrant on ECD 100. The registration request is received at environment control portal 106. It is contemplated that the secondary registrant will typically be registered after the primary registrant is registered (as is described above). However, it is also contemplated the secondary registrant could be registered before the primary registrant, such as an installer (the secondary registrant) registering their information on the ECD 100 prior to the home owner (the primary registrant). The registration request could be initiated on ECD 100, or on a client computing device 101 used by the secondary registrant.

At step 502, the registration module 108 of the server portal 206 attempts authentication of the registration request for the secondary registrant. If necessary, after the server portal 206 receives the registration request, the secondary registrant logs into the portal to complete the registration.

At step 503, upon authenticating the registration request, the server portal 206 assigns the registrant secondary registrant status. The display configuration module 110 of environment control portal 106 configures the respective subset of attributes permitted to be modified by the secondary registrant. Examples of modifiable attributes include the secondary registrant's company logo, service dates, alerts and events.

At step 504, display configuration module 110 of environment control portal 106 forwards the configured pluralities of control attributes to the client computing device 101 belonging to the secondary registrant. As discussed previously, client computing device 101 can include either a personal computer 102a (including both laptops and desktop computers), or a mobile device 102b.

At step 505, a replica screen is displayed at client computing device 101 showing the subset of the control attributes of the touch screen display 222 that the secondary registrant is allowed to access and/or modify. As discussed above, in addition to modifying their own logo and/or contact information, the secondary registrant may see other information such as furnace information, and or equipment error codes, which allows them to determine the appropriate knowledge level of the service technician to dispatch in responding to the service problem, as well as what parts they may need to resolve the service call. The secondary registrant may also be allowed to set a service date in a web portal hosted at the server computer 106, the service date generating an alert to the ECD 100 to remind the primary registrant of upcoming service scheduled for the service date. The secondary registrant may also be allowed to view the heating, ventilating and air conditioning (HVAC) equipment error codes and status information throughout environment control portal 106, for aid in planning routine service work and expediting service delivery. For confirmation purposes, the secondary registrant may be allowed to view ECD 100 location and upcoming service dates for the primary registrant.

At step 506, at the client computing device 101 belonging to the secondary registrant, a modification is made to at least one of the control attributes of the subset of control attributes (as listed above) that the secondary registrant is allowed to modify.

At step 507, the environment control portal 106 receives from the client computing device 101 belonging to the secondary registrant the modification to the one control attribute of the plurality of control attributes of the ECD 100, thereby creating a modified plurality of control attributes, with the modified plurality of control attributes comprising an environment control program.

At step 508, environment control portal 106 forwards the environment control program to the ECD 100 for storage in at least one of memory 224, 226.

Although an environment control and energy management system and method has been used to establish a context for disclosure herein, it is contemplated as having wider applicability. Furthermore, the disclosure herein has been described with reference to specific embodiments; however, varying modifications thereof will be apparent to those skilled in the art without departing from the scope of the invention as defined by the appended claims.

What is claimed is:

1. A method for providing information about a selected environment control device (ECD) to a secondary registrant across a network, the method comprising:
receiving data from a plurality of ECDs at an environment control portal via the network;
receiving a registration request at the environment control portal via the network for registration of a secondary registrant;
authenticating the registration request at the environment control portal;
displaying the registration IDs for a subset of the plurality of ECDs to the secondary registrant, each ECD of the subset of the plurality of ECDs being associated with the secondary registrant;
receiving a selection request from the secondary registrant to display a subset of the data associated with a selected ECD from the subset of the plurality of ECDs; and
broadcasting the subset of data associated with the ECD to the secondary registrant.

2. The method of claim 1, further comprising:
receiving at the environmental control portal from the secondary registrant, a modification made to the subset of data associated with the selected ECD; and
broadcasting the modification made to the subset of data to the selected ECD.

3. The method of claim 2, wherein the subset of data modified by the secondary registrant includes at least one of a company logo and contact information for display of service reminders and service issues.

4. The method of claim 2, wherein the subset of data modified by the secondary registrant includes setting a service date in a web portal hosted at the server computer, the service date for sending to the ECD to remind the primary registrant of upcoming service on the service date.

5. The method of claim 1, further comprising allowing the secondary registrant to view the heating, ventilating and air conditioning (HVAC) equipment error codes and status information throughout an enterprise campus managed by a web portal hosted at the server computer for aid in planning service work and expediting service delivery.

6. The method of claim 1, further comprising allowing the secondary registrant to view ECD location and upcoming service dates for the primary registrant.

7. The method of claim 1, further comprising allowing a secondary registrant to receive, through the web portal, performance information of the ECD in order to better understand the performance of equipment in the field.

8. The method of claim 1, wherein the secondary registrant is a contractor for the primary registrant.

9. The method of claim 2, wherein the secondary registrant can apply the modification to at least two ECDs of the subset of the plurality of ECDs simultaneously.

10. The method of claim 1, wherein the subset of data includes a visual representation of the location of the selected ECD.

11. An environmental control portal for environment control and energy management of an enterprise, the environment control portal comprising:
a server computer having a processor; and
a memory comprising instructions stored thereon, which, when executed in the processor, cause the processor to implement the steps of
receiving data from a plurality of ECDs via the network;
receiving a registration request for via the network for registration of a secondary registrant;
authenticating the registration;
displaying the registration IDs for a subset of the plurality of ECDs to the secondary registrant, each ECD of the subset of the plurality of ECDs being associated with the secondary registrant;
receiving a selection request from the secondary registrant to display a subset of the data associated with a selected ECD from the subset of the plurality of ECDs; and
broadcasting the subset of data associated with the ECD to the secondary registrant.

12. The environmental control portal of claim 11, the processor further implementing the steps of
receiving from the secondary registrant, a modification made to the subset of data associated with the selected ECD; and
broadcasting the subset of data associated with the ECD to the secondary registrant.

13. The environmental control portal of claim 12, wherein the subset of data modified by the secondary registrant includes at least one of a company logo and contact information for display of service reminders and service issues.

14. The environmental control portal of claim 12, wherein the subset of data modified by the secondary registrant includes setting a service date in a web portal hosted at the server computer, the service date for sending to the ECD to remind the primary registrant of upcoming service on the service date.

15. The environmental control portal of claim 11, further being operable to allow the secondary registrant to view the heating, ventilating and air conditioning (HVAC) equipment error codes and status information throughout an enterprise campus managed by a web portal hosted at the server computer for aid in planning service work and expediting service delivery.

16. The environmental control portal of claim 11, further being operable to allow the secondary registrant to view ECD location and upcoming service dates for the primary registrant.

17. The environmental control portal of claim 11, further being operable to allow the secondary registrant to receive, through the web portal, performance information of the ECD in order to better understand the performance of equipment in the field.

18. The environmental control portal of claim 11, wherein the secondary registrant is a contractor for the primary registrant.

19. The environmental control portal of claim 12, wherein the secondary registrant can apply the modification to at least two ECDs of the subset of the plurality of ECDs simultaneously.

20. The environmental control portal of claim 1, wherein the subset of data includes a visual representation of the location of the selected ECD.
